(19) United States
(12) Patent Application Publication
(10) Pub. No.: US 2025/0322386 A1
(43) Pub. Date: Oct. 16, 2025

(54) SYNCHRONIZATION AND DISPLAY OF SELF-CUSTODY ADDRESS TOKENS AND PROFILE TOKENS

(71) Applicant: Coinbase, Inc., Oakland, CA (US)

(72) Inventors: Jeffrey Hinojosa, Woodland Hills, CA (US); Joshua Hyde, Pleasant Valley, CA (US); Shile Zhao, Bellevue, WA (US)

(21) Appl. No.: 18/637,276

(22) Filed: Apr. 16, 2024

(51) Int. Cl. G06Q 20/36; G06Q 20/38

(52) U.S. Cl. CPC G06Q 20/3672; G06Q 20/389

(57) ABSTRACT

Methods, systems, and devices for data management are described. A client application on a user device may display, via a user interface, information about first tokens associated with a profile of a custodial token platform. The client application may receive a first input to connect a self-custody address to the profile of the custodial token platform associated with the client application. After receiving the first input, the client application may receive a second input to authorize the custodial token platform to access and display information associated with the self-custody address at the client application. The client application may obtain an indication of the second tokens associated with the self-custody address via services associated with the custodial token platform and update the user interface to include information about the second tokens associated with the self-custody address concurrently with information about the first tokens associated with the profile.

### FIELD OF TECHNOLOGY

The present disclosure relates generally to data management, including techniques for synchronization and display of self-custody address tokens and profile tokens.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support synchronization and display of self-custody address tokens and profile tokens in accordance with aspects of the present disclosure.

FIGS. 3 and 4 show examples of user interface flows that support synchronization and display of self-custody address tokens and profile tokens in accordance with aspects of the present disclosure.

FIG. 5 shows an example of a process flow that supports synchronization and display of self-custody address tokens and profile tokens in accordance with aspects of the present disclosure.

FIG. 6 shows a block diagram of an apparatus that supports synchronization and display of self-custody address tokens and profile tokens in accordance with aspects of the present disclosure.

FIG. 7 shows a block diagram of a synchronized token display manager that supports synchronization and display of self-custody address tokens and profile tokens in accordance with aspects of the present disclosure.

FIG. 8 shows a diagram of a system including a device that supports synchronization and display of self-custody address tokens and profile tokens in accordance with aspects of the present disclosure.

FIGS. 9 and 10 show flowcharts illustrating methods that support synchronization and display of self-custody address tokens and profile tokens in accordance with aspects of the present disclosure.

### DETAILED DESCRIPTION

A user profile (e.g., account) on a custodial token platform may be associated with one or more token balances. As an example, the user profile may be associated with an amount of a first crypto token, an amount of a second crypto token, and so on. For example, the user profile may be associated with a custodial or semi-custodial wallet. The custodial token platform may store one or more private keys on behalf of the user in the example of the custodial wallet such as to perform actions on the blockchain network. Or, the custodial token platform may store a private key share while the user stores another private key share in the example of a semi-custodial wallet. In some cases, the custodial wallet may be referred to as a hosted wallet or a retail wallet, which may be associated with a retail application of the custodial token platform.

Additionally, or alternatively, a user may have a self-custody address (e.g., self-custody wallet), such as a self-custody address associated with a self-custody (e.g., non-custodial) wallet. For example, the user may possess or access one or more private keys associated with the self-custody wallet to perform actions on a blockchain network. In some cases, the user may use the one or more private keys associated with the self-custody wallet to send, receive, and/or store cryptographic tokens via a blockchain network. However, information associated with the user profile of the custodial token platform and the self-custody address may not be accessible to the user via a same user interface. That is, separate applications may support display of information associated with the user profile and information associated with the self-custody address, respectively. A user experience may be improved by enabling a user interface to display both the information associated with the user profile and the information associated with the self-custody address. In other words, the user experience may be enhanced via display of different balances of the user stored at the user profile and at the self-custody address on a same user interface.

As described herein, the custodial token platform may support synchronization and display of self-custody address tokens and profile tokens at a same user interface. For example, a client application of the custodial token platform may display an option to connect a self-custody address to a profile of the custodial token platform. After receiving an input selecting the option to connect the self-custody address to the profile, the client application may display a policy associated with connecting the self-custody address to the profile. For example, the policy may include an indication that, if a user opts to connect the self-custody address to the profile, the custodial token platform may access information associated with the self-custody address and/or be enabled to perform actions (e.g., send, receive, and/or trade crypto tokens) from the self-custody address on the client application. The custodial token platform may, after receiving an input agreeing to the policy and authorizing the custodial token platform to access the information associated with the self-custody address, obtain the information associated with the self-custody address via one or more services. For example, the one or more services may store an association between the profile of the custodial token platform and the self-custody address. After obtaining the information associated with the self-custody address, a user interface of the client application may display the information associated with the self-custody address and information associated with the profile concurrently. As an example, the client application may display an amount of tokens, message activity, non-fungible tokens (NFTs), or the like associated with both the self-custody address and the profile via the user interface.

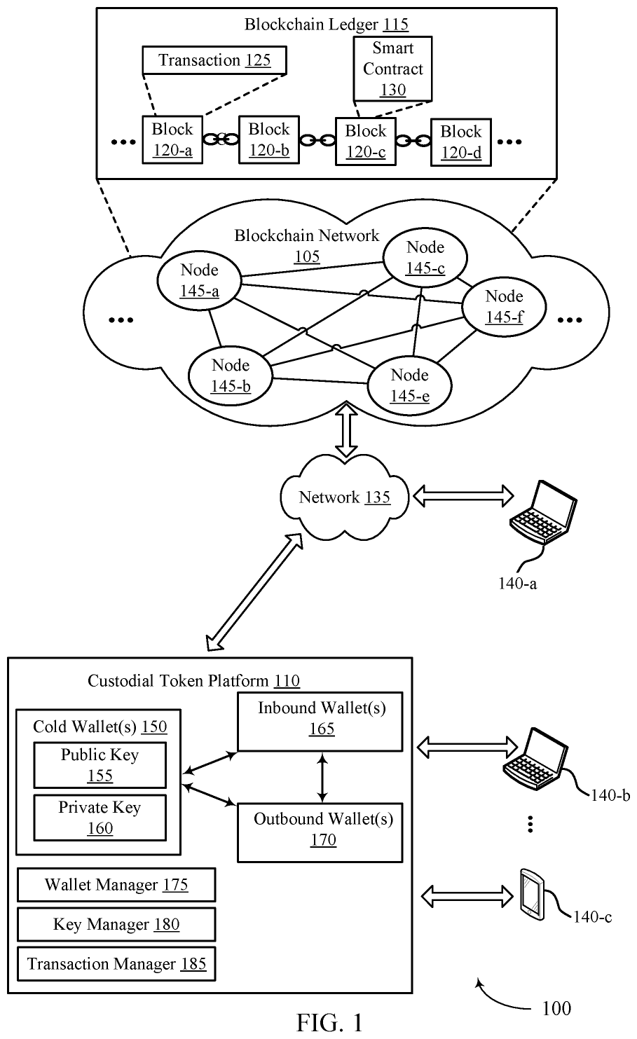

FIG. 1 illustrates an example of a computing environment 100 that supports synchronization and display of self-custody address tokens and profile tokens in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

The custodial token platform 110 may support a client application at a computing device, such as the computing device 140-b or the computing device 140-c. For example, the client application may support access to a profile of the custodial token platform 110 via the computing device. Additionally, as described herein, the client application may support concurrent display of information associated with the profile and information associated with a self-custody address. The profile may be associated with one or more first tokens stored by the custodial token platform 110 on behalf of a user, whereas the self-custody address may be associated with one or more second tokens stored at the self-custody address via the blockchain network 105. For example, the blockchain network 105 may store a record of the association between the self-custody address and the one or more second tokens, such as on a blockchain ledger 115. The custodial token platform 110 may, via one or more services, may obtain information associated with the self-custody address such that a user of the custodial token platform 110 having the profile and the self-custody address may view assets associated with each wallet via a same user interface.

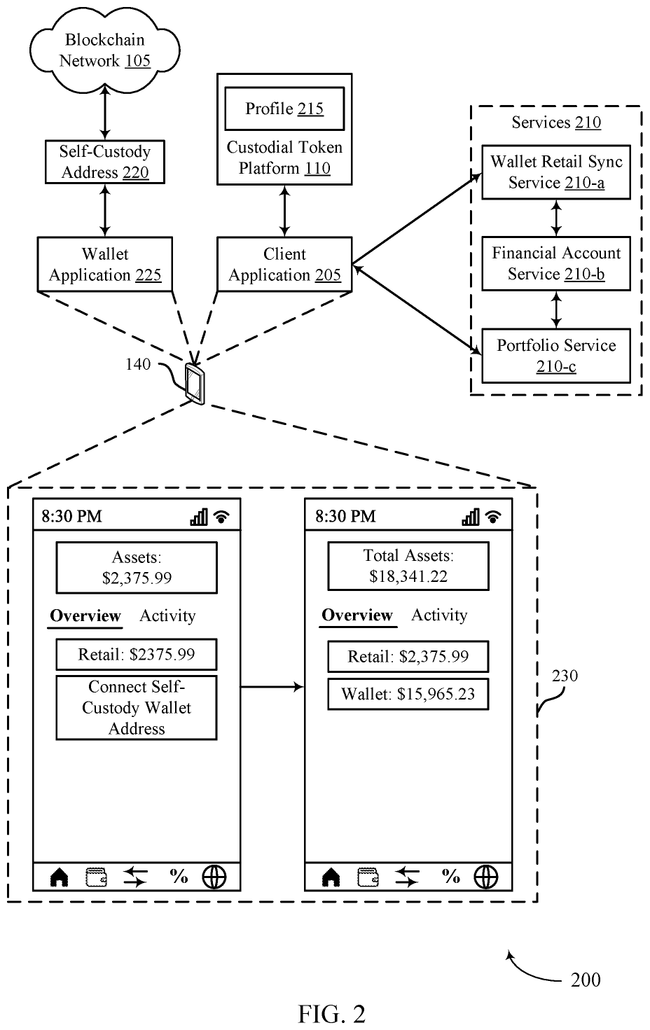

FIG. 2 shows an example of a computing environment 200 that supports synchronization and display of self-custody address tokens and profile tokens in accordance with aspects of the present disclosure. The computing environment 200 may include a blockchain network 105, a custodial token platform 110, and a computing device 140 which may be examples of the blockchain network 105, the custodial token platform 110, and the computing device 140, respectively, as described with reference to FIG. 1. The computing environment 200 may also include a client application 205 and a wallet application 225, which may be supported by or implemented by a custodial token platform 110 or another system or service as described with reference to FIG. 1.

The client application 205 may display, via a user interface 230 of the computing device 140, assets associated with a profile 215 of the custodial token platform 110. For example, the client application 205 may display one or more first tokens, which may be examples of one or tokens associated with a retail account (e.g., profile 215) at the custodial token platform 110, via the user interface. Additionally, the client application 205 and/or the wallet application 225 may display an option to connect a self-custody wallet address to the profile 215. For example, the client application 205 may support a connection of the profile 215 to a self-custody address 220, where, after the connection, the client application 205 may concurrently display information associated with both the profile 215 and the self-custody address 220. In some examples, the self-custody address 220 may be associated with a wallet application 225. The wallet application 225 may be supported by or otherwise associated with the custodial token platform 110 or may be provided or supported by a separate wallet service. However, a user may possess one or more keys associated with the self-custody address 220, whereas the custodial token platform 110 may possess (e.g., at least partially) one or more keys associated with the profile 215. Additionally, or alternatively, the self-custody address 220 may be associated with a capability to broadcast messages (e.g., signed via the one or more keys associated with the self-custody address 220) via the blockchain network 105. As an example, the self-custody address 220 may have a capability to interact with the blockchain network 105, including Dapps, Web3, or the like. The client application 205 may also be associated with a capability to broadcast messages via the blockchain network 105 via the custodial token platform 110. That is, the user may access the client application 205 to perform actions, and the custodial token platform 110 may perform functions (e.g., signing and broadcasting) to interact via the blockchain network 105.

The client application 205 may support the connection via services 210 associated with the custodial token platform 110. For example, the services 210 may include a wallet retail sync service 210-a, a financial account service 210-b, and/or a portfolio service 210-c.

The wallet retail sync service 210-a may facilitate a synchronization of association between the profile 215 and the self-custody address 220. The wallet retail sync service 210-a may initiate an addition or removal of a self-custody address from association with the profile 215. For example, the wallet retail sync service 210-a may receive requests via the client application 205 and send messages to the financial account service 210-b indicating to add or remove a self-custody address from association with the profile 215 based on the requests. In the example of FIG. 2, the wallet retail sync service 210-a may receive a request from the client application 205 that the self-custody address 220 be added to a list of addresses associated with the profile 215 at the financial account service 210-b The request may include an indication of the profile 215, the self-custody address 220, and a network associated with the computing device 140.

In some examples, the wallet retail sync service 210-a may enforce a threshold of requests, such as a rate limit. For example, the wallet retail sync service 210-a may refrain from receiving requests to associate self-custody addresses and profiles based on a threshold being met. The threshold quantity may represent a threshold quantity of wallet addresses (e.g., self-custody addresses), a threshold quantity of networks, or both. For example, the wallet retail sync service 210-a may enforce the threshold to prevent a security breach at the custodial token platform 110.

The wallet retail sync service 210-a may facilitate the synchronization of the association between the profile 215 and the self-custody address 220 based on an authentication of a user of the custodial token platform 110. For example, the wallet retail sync service 210-a may facilitate the synchronization based on receiving an authentication token indicating an identity of the user and/or that the user is authenticated. That is, the wallet retail sync service 210-a may receive the request and/or send messages to the financial account service 210-b to generate the association based on the authentication of the user.

The financial account service 210-b may store an association between the profile 215 and the self-custody address 220. The financial account service 210-b may receive submissions from the wallet retail sync service 210-a. The submissions may include an indication the profile 215 and the self-custody address 220, such as including an identifier of the user, an address, a type of address, and/or ownership of tokens associated with the profile 215 and/or the self-custody address 220 (e.g., whether the profile 215 or the self-custody address 220 is associated with a non-custodial wallet). In some examples, the submission may include a message signed via the self-custody address 220 (e.g., based on a type of non-custodial wallet). For example, the submission may not include the message signed via the self-custody address 220 based on the self-custody address 220 being associated with a wallet application 225. After receiving the submission, the financial account service 210-b may store the association (e.g., a mapping).

The portfolio service 210-c may calculate balances of assets within a wallet, such as within the self-custody address 220. For example, the portfolio service 210-c may receive requests, such as from the financial account service 210-b, to retrieve a wallet balance associated with the self-custody address 220. In other words, the portfolio service 210-c may retrieve information associated with assets of the self-custody address 220. The information may be associated with one or more tokens, NFTs, or the like of the self-custody address 220. Additionally, or alternatively, the information may be associated with transaction history of the self-custody address 220. For example, the portfolio service 210-c may retrieve a record of one or more messages broadcast to the blockchain network 105 signed by the self-custody address 220. Such information may be retrieved from one or more nodes (e.g., nodes 145 of FIG. 1) of the blockchain networks, and the one or more nodes may be managed by the custodial token platform 110 or another service or entity. The portfolio service 210-c may provide the information associated with the self-custody address 220 to the client application 205. For example, the client application 205 may display information associated with the self-custody address 220 based on receiving the information from the portfolio service 210-c. As illustrated by the example of FIG. 2, the client application 205 may display an amount of tokens associated with the self-custody address 220.

In other words, the client application 205 may update the user interface 230 of the computing device 140 to display one or more tokens associated with the self-custody address 220 concurrently with one or more tokens associated with the profile 215. In some examples, the client application 205 may (e.g., periodically) retrieve updated information associated with the self-custody address 220 via the services 210. For example, the portfolio service 210-c may provide the updated information associated with the self-custody address 220 to the client application 205.

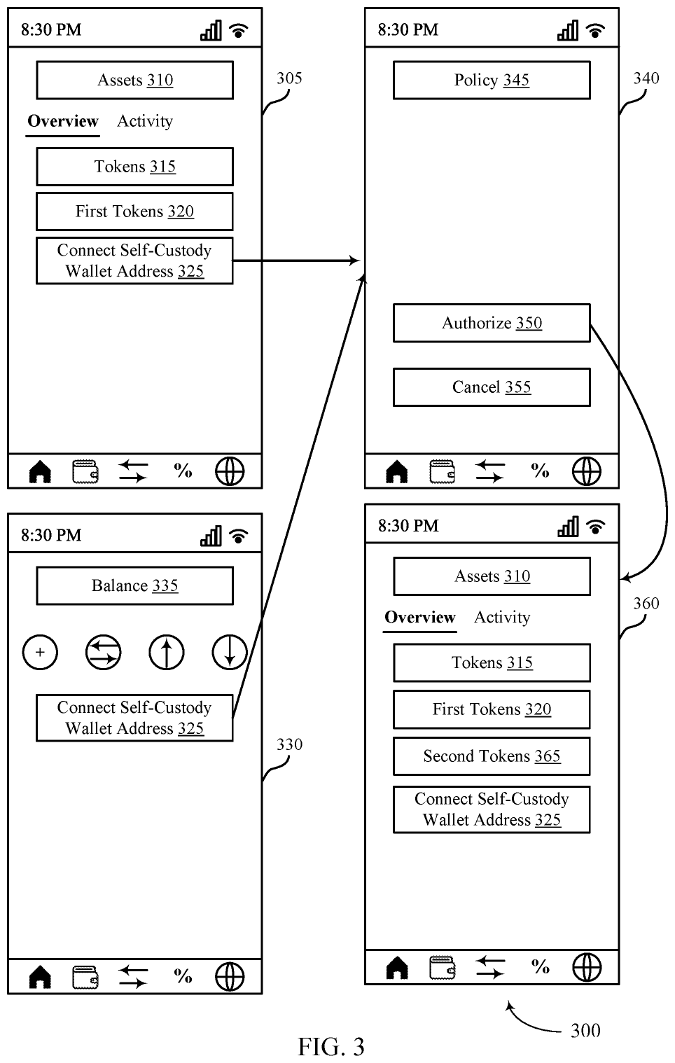

FIG. 3 shows an example of a user interface flow 300 that supports synchronization and display of self-custody address tokens and profile tokens in accordance with aspects of the present disclosure. In some examples, the user interface flow 300 may implement or be implemented by aspects of the computing environment 100 as described with reference to FIG. 1. For example, the user interface flow 300 may illustrate a display of one or more indications at a client application, such as the client application 205 as described with reference to FIG. 2. In some examples, one or more indications illustrated via the user interface flow 300, such as an option to connect, may be displayed at a wallet application, such as the wallet application 225 as described with reference to FIG. 2. Alternative examples of the following user interface flow may be implemented, where display of some indications may be in a different order than described or are not displayed at all. In some cases, the user interface flow 300 may include additional indications not mentioned below, or further indications may be added.

A user interface may display multiple content items in accordance with synchronization and display of self-custody address tokens and profile tokens. The user interface flow 300 includes an example of the user interface where multiple content items may be displayed to enable a user to view information associated with a retail account and a self-custody wallet.

At 305, the user interface may display assets 310 associated with a profile of a custodial token platform (e.g., a retail account), such as the profile 215 of the custodial token platform 110 as described with reference to FIG. 2. The user interface may display the assets 310 in accordance with a selection of an assets tab of the client application. The assets tab may include the assets 310, an overview of assets associated with the profile, and activity associated with the profile. For example, the assets tab may display tokens 315, including first tokens 320. The first tokens 320 may be an example of crypto tokens, such as various tokens described with respect to FIG. 1. The first tokens 320 may be tokens of a semi-custodial or custodial wallet where a private key associated with the wallet is stored, at least in part, by an entity other than the user. For example, the custodial token platform may store and manage a share of the private key or the private key entirely. The assets tab may also display an option to connect a self-custody wallet address 325.

Additionally, or alternatively, at 330, the user interface may display a balance 335 and the option to connect the self-custody wallet address 325. The user interface may display the balance 335 in accordance with a selection of a home tab of the client application. The home tab may include one or more options to buy, trade, send, or receive assets via the custodial token platform. For example, via the home tab, the user may provide a selection to buy one or more tokens. Additionally, the home tab may include the option to connect the self-custody wallet address 325. In some examples, the user interface may display the option to connect the self-custody wallet address via a card of the home tab.

As illustrated in the example of FIG. 3, a user of the client application may opt to connect the self-custody wallet address via one or more locations within the client application, including the assets tab and the home tab. While the option to connect the self-custody wallet address 325 is included in the context of the assets tab and the home tab in the example of FIG. 3, it may be understood that the option to connect the self-custody wallet address 325 may be included at one or more additional or alternate locations. In some examples, such as if a self-custody address is connected to the profile prior to 305 or 325, the client application may display an option to display information associated with the self-custody address. For example, the client application may display the information associated with the self-custody address based on receiving an indication of a selection of the option to display the information, or display an option (e.g., within the assets tab) to display the information based on receiving an indication of a selection to not display the information. If the client application receives an indication of a selection of the option to connect the self-custody wallet address 325, the client application may display, at 340, a policy 345 associated with the connection.

The policy 345 may indicate one or more permissions to be granted to the custodial token platform in order to connect the self-custody wallet address. For example, the permissions may include allowing the custodial token platform to access to account information, send tokens from the account, buy crypto, and display information associated with the self-custody address at the user interface of the client application. The user interface may also display an option to authorize 350 or an option to cancel 355. That is, the user interface may display the option to authorize 350 the custodial token platform to access and display information and/or perform one or more actions as indicated via the policy 345. Additionally, the user interface may display the option to cancel 355 connecting the self-custody wallet address to the profile.

At 360, in response to receiving an indication of a selection of the option to authorize 350, the client application may update a display of the assets tab. For example, the assets tab may be updated to include the tokens 315 including the first tokens 320 associated with the profile and second tokens 365 associated with the self-custody address. In some examples, an amount indicated in the assets 310 may increase proportionally to the second tokens 365. That is, the client application may update the amount indicated in the assets 310 to include the second tokens 365 associated with the self-custody address. In some examples, the activity tab at 365 may include activity (e.g., sending, receiving, and/or buying tokens) associated with the profile and the self-custody address. For example, the activity tab may include one or more transactions associated with the self-custody address in addition to transactions associated with the profile.

The client application may display the option to connect the self-custody wallet address 325 after updating the display such that the user may connect another self-custody wallet. That is, the client application may support display of information associated with multiple self-custody wallets.

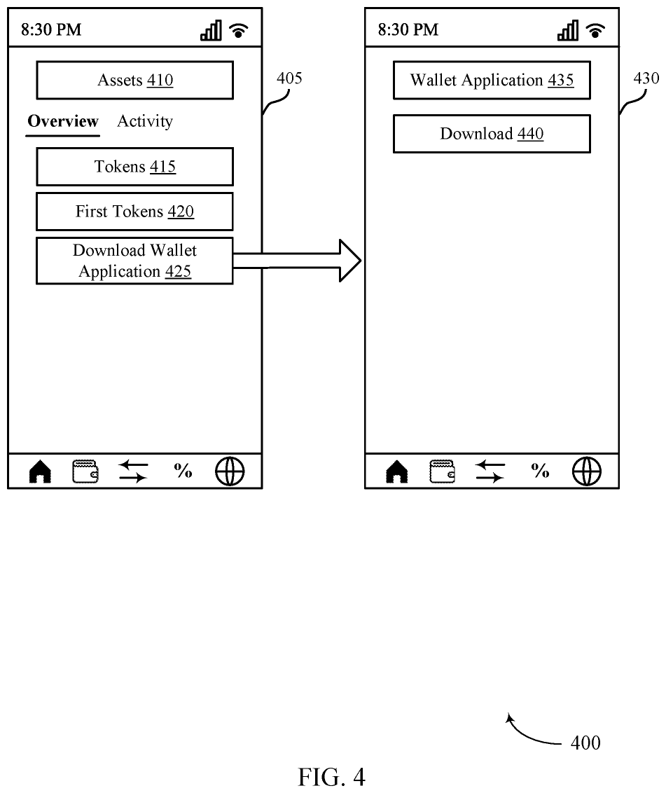

FIG. 4 shows an example of a user interface flow 400 that supports synchronization and display of self-custody address tokens and profile tokens in accordance with aspects of the present disclosure. In some examples, the user interface flow 400 may implement or be implemented by aspects of the computing environment 100 as described with reference to FIG. 1. For example, the user interface flow 400 may illustrate a display of one or more indications at a client application, such as the client application 205 as described with reference to FIG. 2. Alternative examples of the following user interface flow may be implemented, where display of some indications may be in a different order than described or are not displayed at all. In some cases, the user interface flow 400 may include additional indications not mentioned below, or further indications may be added.

A user interface may display multiple content items in accordance with synchronization and display of self-custody address tokens and profile tokens. The user interface flow 400 includes an example of the user interface where multiple content items may be displayed to enable a user to view information associated with a retail account and a self-custody wallet.

At 405, the user interface may display assets 410 associated with a profile of a custodial token platform, such as the profile 215 of the custodial token platform 110 as described with reference to FIG. 2. The user interface may display the assets 410 in accordance with a selection of an assets tab of the client application. The assets tab may include the assets 410, an overview of assets associated with the profile, and activity associated with the profile. For example, the assets tab may display tokens 415, including first tokens 420. The first tokens 420 may be an example of crypto tokens, such as the crypto tokens described herein. The first tokens 420 may be tokens of a semi-custodial or custodial wallet where a private key associated with the wallet is stored, at least in part, by an entity other than the user. For example, the custodial token platform store or manage a share of the private key or the private key entirely. The assets tab may also display an option to download a wallet application 425. For example, the assets tab may include the option to download the wallet application 425 based on a device having the client application not having the wallet application.

If the client application receives an indication of a selection of the option to download the wallet application 425, the device may display, at 430, a wallet application 435 and an option to download 440. For example, after receiving the selection of the option to download the wallet application 425, the device may display an option to download 440. After downloading the wallet application (e.g., after the device receives a selection of the option to download 440), the client application may display options to connect a self-custody wallet address, such as the option to connect the self-custody wallet address 325 as described with reference to FIG. 3.

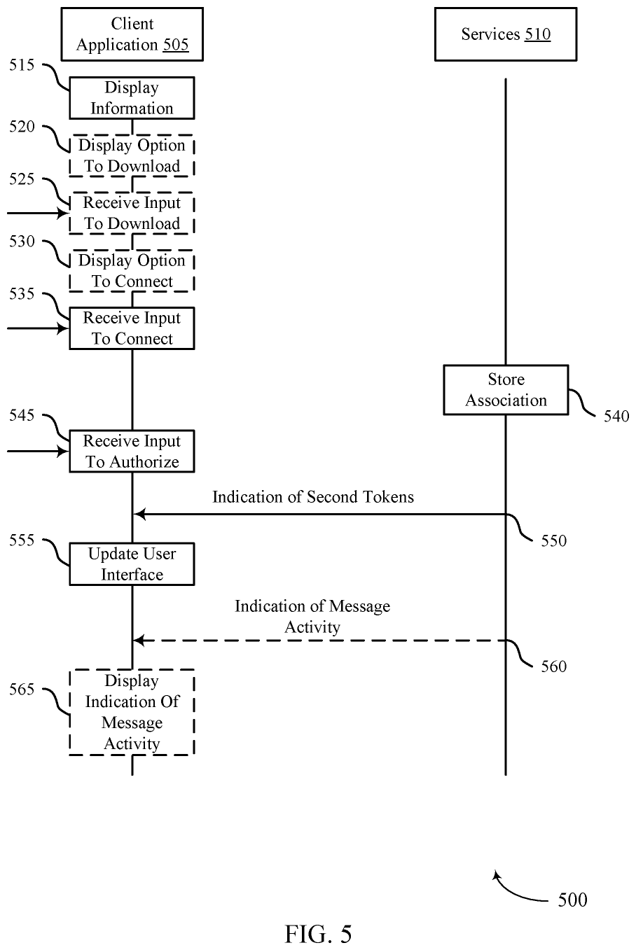

FIG. 5 shows an example of a process flow 500 that supports synchronization and display of self-custody address tokens and profile tokens in accordance with aspects of the present disclosure. In some examples, the process flow 500 may implement or be implemented by aspects of the computing environment 100, the computing environment 200, the user interface flow 300, and/or the user interface flow 400 as described with reference to FIGS. 1 through 4. For example, the process flow 500 may include a client application 505 and services 510, which may be examples of the client application 205 and the services 210 as described with reference to FIG. 2.

Alternative examples of the following may be implemented, where some steps are performed in a different order than described or are not performed at all. In some cases, steps may include additional features not mentioned below, or further steps may be added. Although the client application 505 and the services 510 are shown performing the steps of the process flow 500, some aspects of some operations may also be performed by one or more other components.

At 515, the client application 505 may display information via a user interface. For example, the client application 505 may display, via the user inter interface on a user device, information about one or more first tokens associated with a profile of a custodial token platform, such as the custodial token platform 110 as described with reference to FIGS. 1 and 2. The user device may be an example of a computing device, such as the computing device 140 as described with reference to FIGS. 1 and 2. The one or more first tokens may be an example of the crypto tokens, such as the crypto tokens as described with reference to FIG. 1, or the first tokens 320 or the first tokens 420 as described with reference to FIGS. 3 and 4, respectively. The profile may be an example of the profile 215 as described with reference to FIG. 2. In some examples, the first tokens associated with the profile of the custodial token platform may be stored by the custodial token platform on behalf of a user associated with the profile. That is, the first tokens may be of a custodial or semi-custodial wallet, where the keys associated with the wallet are stored, at least partially, by the custodial token platform.

At 520, the client application 505 may display an option to download via the user interface. For example, the client application 505 may display, via the user interface, an option to download an application associated with a self-custody address. For example, the application associated with the self-custody address may be an example of the wallet application 225 associated with the self-custody address 220 as described with reference to FIG. 2. The self-custody address may be associated with one or more keys having a capability to send, receive, store, or any combination thereof cryptographic tokens on a blockchain network, such as the blockchain network 105 as described with reference to FIGS. 1 and 2. Additionally, or alternatively, the option to download the application may be an example of the option to download the wallet application 425 as described with reference to FIG. 4. At 525, the client application 505 may receive an input to download. For example, after displaying the option to download, the user device may receive an input to download the application associated with the self-custody address. For example, the input to download may be based on a selection of the option to download 440 as described with reference to FIG. 4.

At 530, the client application 505 may display an option to connect via the user interface. For example, the client application 505 may display, at the user interface, an option to connect the self-custody address to the profile of the custodial token platform associated with the client application. Additionally, or alternatively, a wallet application, such as the wallet application 225 as described with reference to FIG. 2 may display the option to connect. The option to connect may be an example of the option to connect self-custody wallet address 325 as described with reference to FIG. 3. In some examples, the client application 505 may display the option to connect based on the user device having the application associated with the self-custody address. For example, the client application 505 may display the option to connect based on the user device having the application after receiving the input to download at 525. At 535, the client application 505 may receive an input to connect. For example, the client application 505 may receive the input to connect the self-custody address to the profile of the custodial token platform after displaying the option to connect at 530. In some cases, the user may enter information associated with the self-custody wallet, such as the wallet address. Additionally, or alternatively, the client application 505 may be configured to retrieve such information via the wallet application on the user device, the services 510, or a combination thereof.

At 540, the services 510 may store an association. For example, the services 510 may store an association between the profile of the custodial token platform and the self-custody address. The services 510 may be an example of the services 210 as described with reference to FIG. 2. In some examples, the services 510 may include one or more of the wallet retail sync service 210-a, the financial account service 210-b, or the portfolio service 210-c as described with reference to FIG. 2.

At 545, the client application 505 may receive an input to authorize. For example, the client application 505 may receive an input to authorize, such as a selection of the option to authorize 350 as described with reference to FIG. 3, the custodial token platform to access information associated with the self-custody address and display information about one or more second tokens associated with the self-custody address at the client application. In some examples, receiving the input to authorize may be in response to displaying, at the user interface of the client application 505, a policy associated with connecting the profile to the self-custody address. For example, the client application 505 may receive the input to authorize after displaying the policy, such as the policy 345 as described with reference to FIG. 3. Additionally, or alternatively, the client application 505 may display the policy and/or receive the input to authorize based on receiving the input to connect at 535.

In some examples, receiving the input to authorize may include receiving the input to authorize the custodial token platform to perform activities via the blockchain network. For example, the custodial token platform may send tokens from the profile to the self-custody address, send tokens from the self-custody address to the profile, or purchase tokens via the custodial token platform after connecting the profile to the self-custody address. That is, the user may exchange tokens between the profile and the self-custody address and/or purchase tokens via the custodial token platform after the connection.

At 550, the client application 505 may obtain an indication of second tokens via the services 510. For example, the client application 505 may obtain the indication of second tokens associated with the self-custody address via the services 510 associated with the custodial token platform. In some examples, obtaining the indication may include obtaining an amount of tokens associated with the self-custody address, content of NFTs associated with the self-custody address, or both.

The client application 505 may obtain the indication of the second tokens based on the services 510 storing the association between the profile and the self-custody address. Additionally, or alternatively, the client application 505 may obtain the indication of the second tokens based on receiving the input to authorize at 545. The second tokens may be an example of the wallet tokens as described with reference to FIG. 2 or the second tokens 365 as described with reference to FIG. 3. In some examples, the second tokens may be associated with the self-custody address according to one or more records on a blockchain data store associated with a blockchain network. For example, a blockchain ledger, such as the blockchain ledger 115 as described with reference to FIG. 1, may include a record of the second tokens being associated with the self-custody address.

At 555, the client application 505 may update a user interface. For example, the client application 505 may update the user interface, after obtaining the indication of the second tokens at 550, to include information about the one or more second tokens associated with the self-custody address concurrently with information about the one or more first tokens associated with the profile of the custodial token platform. For example, the client application 505 may display the first tokens and the second tokens via a same user interface, such as in the user interface in the example of FIG. 2 or at 365 of FIG. 3.

At 560, the client application 505 may obtain an indication of message activity via the services 510. For example, the client application 505 may obtain the indication of the message activity associated with the self-custody address via the services 510 associated with the custodial token platform. At 565, after obtaining the indication of the message activity at 560, the client application 505 may display an indication of message activity via the user interface. For example, the client application 505 may display an indication of messages broadcast to a blockchain network associated with the self-custody address, such as in association with a blockchain transaction.

In some examples, the client application 505 may connect more than one self-custody address to the profile. For example, the client application 505 may receive an input to connect a second self-custody address and, in response to receiving the input, obtain an indication of third tokens associated with the second self-custody address to be displayed via the user interface. The client application 505 may update the user interface to display information about the first tokens, second tokens, and third tokens concurrently. In other words, the client application 505 may repeat any of the operations at 530 through 565 with respect to additional self-custody addresses.

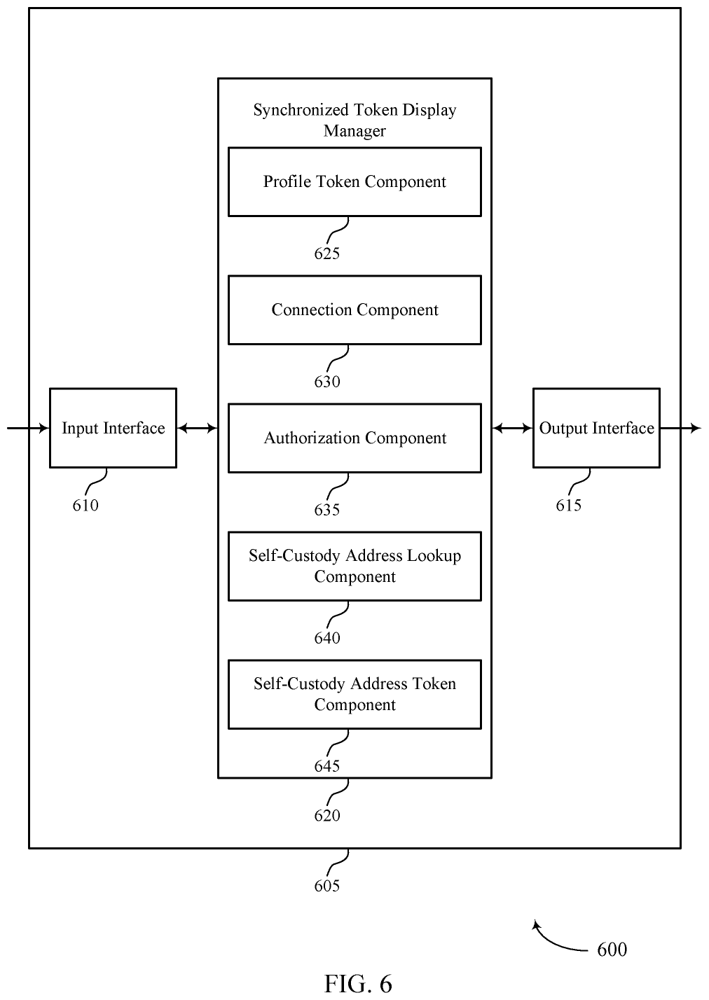

FIG. 6 shows a block diagram 600 of a system 605 that supports synchronization and display of self-custody address tokens and profile tokens in accordance with aspects of the present disclosure. The system 605 may include an input interface 610, an output interface 615, and a synchronized token display manager 620. The system 605, or one or more components of the system 605 (e.g., the input interface 610, the output interface 615, the synchronized token display manager 620), may include at least one processor, which may be coupled with at least one memory, to support the described techniques. Each of these components may communicate, directly or indirectly, with one another (e.g., via one or more buses, communications links, communications interfaces, or any combination thereof).

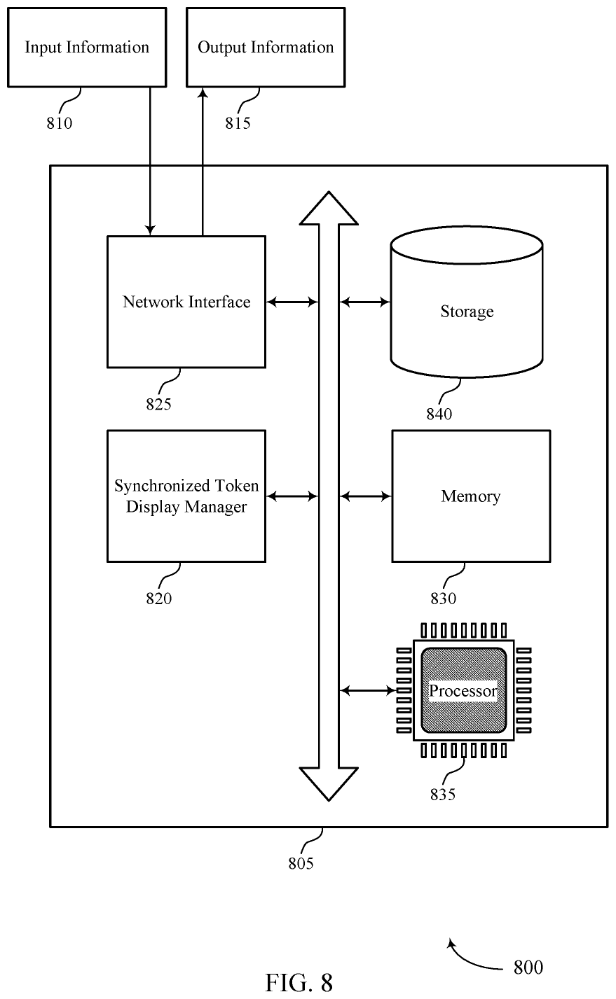

The input interface 610 may manage input signaling for the system 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the synchronized token display manager 620 to support synchronization and display of self-custody address tokens and profile tokens. In some cases, the input interface 610 may be a component of a network interface 825 as described with reference to FIG. 8.

The output interface 615 may manage output signaling for the system 605. For example, the output interface 615 may receive signaling from other components of the system 605, such as the synchronized token display manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the synchronized token display manager 620 may include a profile token component 625, a connection component 630, an authorization component 635, a self-custody address lookup component 640, a self-custody address token component 645, or any combination thereof. In some examples, the synchronized token display manager 620, or various components thereof, may be configured to perform various operations (e.g., receiving, monitoring, transmitting) using or otherwise in cooperation with the input interface 610, the output interface 615, or both. For example, the synchronized token display manager 620 may receive information from the input interface 610, send information to the output interface 615, or be integrated in combination with the input interface 610, the output interface 615, or both to receive information, transmit information, or perform various other operations as described herein.

The synchronized token display manager 620 may support data management in accordance with examples as disclosed herein. The profile token component 625 may be configured as or otherwise support a means for displaying, at a user interface of a client application on a user device, information about one or more first tokens associated with a profile of a custodial token platform. The connection component 630 may be configured as or otherwise support a means for receiving, via the client application on the user device, a first input to connect a self-custody address to the profile of the custodial token platform. The authorization component 635 may be configured as or otherwise support a means for receiving, via the client application and after receiving the first input, a second input to authorize the custodial token platform to access information associated with the self-custody address and display information about one or more second tokens associated with the self-custody address at the client application. The self-custody address lookup component 640 may be configured as or otherwise support a means for obtaining an indication of the one or more second tokens associated with the self-custody address via one or more services associated with the custodial token platform, wherein at least one service of the one or more services stores an association between the profile of the custodial token platform and the self-custody address. The self-custody address token component 645 may be configured as or otherwise support a means for updating the user interface of the client application, after obtaining the indication of the one or more second tokens, to include information about the one or more second tokens associated with the self-custody address concurrently with information about the one or more first tokens associated with the profile of the custodial token platform.

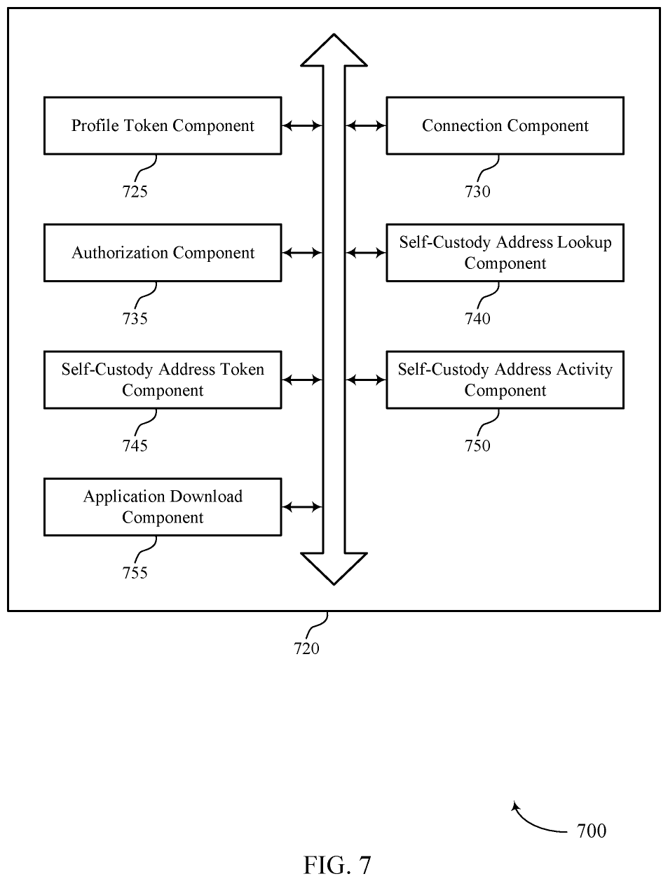

FIG. 7 shows a block diagram 700 of a synchronized token display manager 720 that supports synchronization and display of self-custody address tokens and profile tokens in accordance with aspects of the present disclosure. The synchronized token display manager 720 may be an example of aspects of a synchronized token display manager or a synchronized token display manager 620, or both, as described herein. The synchronized token display manager 720, or various components thereof, may be an example of means for performing various aspects of synchronization and display of self-custody address tokens and profile tokens as described herein. For example, the synchronized token display manager 720 may include a profile token component 725, a connection component 730, an authorization component 735, a self-custody address lookup component 740, a self-custody address token component 745, a self-custody address activity component 750, an application download component 755, or any combination thereof. Each of these components may communicate, directly or indirectly, with one another (e.g., via one or more buses, communications links, communications interfaces, or any combination thereof).

The synchronized token display manager 720 may support data management in accordance with examples as disclosed herein. The profile token component 725 may be configured as or otherwise support a means for displaying, at a user interface of a client application on a user device, information about one or more first tokens associated with a profile of a custodial token platform. The connection component 730 may be configured as or otherwise support a means for receiving, via the client application on the user device, a first input to connect a self-custody address to the profile of the custodial token platform. The authorization component 735 may be configured as or otherwise support a means for receiving, via the client application and after receiving the first input, a second input to authorize the custodial token platform to access information associated with the self-custody address and display information about one or more second tokens associated with the self-custody address at the client application. The self-custody address lookup component 740 may be configured as or otherwise support a means for obtaining an indication of the one or more second tokens associated with the self-custody address via one or more services associated with the custodial token platform, wherein at least one service of the one or more services stores an association between the profile of the custodial token platform and the self-custody address. The self-custody address token component 745 may be configured as or otherwise support a means for updating the user interface of the client application, after obtaining the indication of the one or more second tokens, to include information about the one or more second tokens associated with the self-custody address concurrently with information about the one or more first tokens associated with the profile of the custodial token platform.

In some examples, the connection component 730 may be configured as or otherwise support a means for displaying, at the user interface of the client application, a first option to connect the self-custody address to the profile of the custodial token platform associated with the client application, wherein receiving the first input is based at least in part on displaying the first option.

In some examples, the application download component 755 may be configured as or otherwise support a means for displaying, at the user interface of the client application, a second option to download an application associated with the self-custody address. In some examples, the application download component 755 may be configured as or otherwise support a means for receiving, at the user device, a third input to download the application associated with the self-custody address, wherein displaying the first option to connect the self-custody address to the profile of the custodial token platform associated with the client application is based at least in part on receiving the third input.

In some examples, the connection component 730 may be configured as or otherwise support a means for receiving, via the client application on the user device, a third input to connect a second self-custody address to the profile of the custodial token platform. In some examples, the self-custody address lookup component 740 may be configured as or otherwise support a means for obtaining, after receiving the third input, a second indication of one or more third tokens associated with the second self-custody address via the one or more services associated with the custodial token platform. In some examples, the self-custody address token component 745 may be configured as or otherwise support a means for updating the user interface of the client application, after obtaining the second indication of the one or more third tokens, to include information about the one or more third tokens associated with the second self-custody address concurrently with information about the one or more first tokens associated with the profile of the custodial token platform and information about the one or more second tokens associated with the self-custody address.

In some examples, the self-custody address activity component 750 may be configured as or otherwise support a means for obtaining a second indication of message activity associated with the self-custody address via one or more services associated with the custodial token platform. In some examples, the self-custody address activity component 750 may be configured as or otherwise support a means for displaying, at the user interface of the client application and after obtaining the indication of the one or more second tokens, the second indication of the message activity associated with the self-custody address.

In some examples, to support obtaining the indication, the self-custody address lookup component 740 may be configured as or otherwise support a means for obtaining an amount of tokens associated with the self-custody address, obtaining content of one or more NFTs associated with the self-custody address, or both.

In some examples, to support receiving the second input to authorize the custodial token platform to access the information associated with the self-custody address and display the one or more second tokens associated with the self-custody address at the client application, the authorization component 735 may be configured as or otherwise support a means for receiving the second input to authorize the custodial token platform to perform one or more activities via a blockchain network, the one or more activities comprising sending one or more third tokens from the profile to the self-custody address, sending the one or more third tokens from the self-custody address to the profile, purchasing the one or more third tokens via the custodial token platform, or any combination thereof.

In some examples, the self-custody address is associated with one or more keys, the one or more keys associated with a capability of the self-custody address to send, receive, store, or any combination thereof cryptographic tokens via a blockchain network.

In some examples, the one or more first tokens associated with the profile of the custodial token platform are stored by the custodial token platform on behalf of a user associated with the profile.

In some examples, the one or more second tokens are associated with the self-custody address according to one or more records on a blockchain data store associated with a blockchain network.

FIG. 8 shows a diagram of a system 800 including a system 805 that supports synchronization and display of self-custody address tokens and profile tokens in accordance with aspects of the present disclosure. The system 805 may be an example of or include components of a system 605 as described herein. The system 805 may include components for data processing and communications and blockchain network access, including components for transmitting and receiving communications, such as a synchronized token display manager 820, an input information 810, an output information 815, a network interface 825, at least one memory 830, at least one processor 835, and a storage 840. Each of these components may communicate, directly or indirectly, with one another (e.g., via one or more buses, communications links, communications interfaces, or any combination thereof).

The network interface 825 may enable the system 805 to exchange information (e.g., input information 810, output information 815, or both) with other systems or devices (not shown). For example, the network interface 825 may enable the system 805 to connect to a network (e.g., a network 135 as described herein). The network interface 825 may include one or more wireless network interfaces, one or more wired network interfaces, or any combination thereof.

Memory 830 may include RAM, ROM, or both. The memory 830 may store computer-readable, computer-executable software including instructions that, when executed, cause at least one processor 835 to perform various functions described herein, such as functions supporting synchronization and display of self-custody address tokens and profile tokens. In some cases, the memory 830 may contain, among other things, a basic input/output system (BIOS), which may control basic hardware or software operation such as the interaction with peripheral components or devices. In some cases, the memory 830 may be an example of aspects of one or more components of a custodial token platform 110 as described with reference to FIG. 1. The memory 830 may be an example of a single memory or multiple memories. For example, the system 805 may include one or more memories 830.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting synchronization and display of self-custody address tokens and profile tokens). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. The processor 835 may be an example of a single processor or multiple processors. For example, the system 805 may include one or more processors 835.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1.

The synchronized token display manager 820, which may be an example of aspects of a client application described herein, may support data management in accordance with examples as disclosed herein. For example, the synchronized token display manager 820 may be configured as or otherwise support a means for displaying, at a user interface of a client application on a user device, information about one or more first tokens associated with a profile of a custodial token platform. The synchronized token display manager 820 may be configured as or otherwise support a means for receiving, via the client application on the user device, a first input to connect a self-custody address to the profile of the custodial token platform. The synchronized token display manager 820 may be configured as or otherwise support a means for receiving, via the client application and after receiving the first input, a second input to authorize the custodial token platform to access information associated with the self-custody address and display information about one or more second tokens associated with the self-custody address at the client application. The synchronized token display manager 820 may be configured as or otherwise support a means for obtaining an indication of the one or more second tokens associated with the self-custody address via one or more services associated with the custodial token platform, wherein at least one service of the one or more services stores an association between the profile of the custodial token platform and the self-custody address. The synchronized token display manager 820 may be configured as or otherwise support a means for updating the user interface of the client application, after obtaining the indication of the one or more second tokens, to include information about the one or more second tokens associated with the self-custody address concurrently with information about the one or more first tokens associated with the profile of the custodial token platform.

By including or configuring the synchronized token display manager 820 in accordance with examples as described herein, the system 805 may support techniques for improved user experience related to simultaneous display of wallet and retail tokens and/or activity.

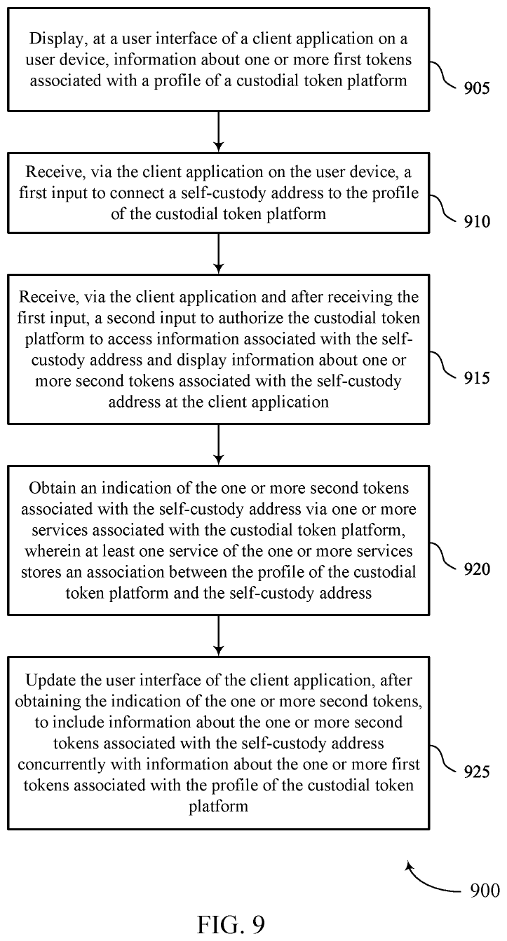

FIG. 9 shows a flowchart illustrating a method 900 that supports synchronization and display of self-custody address tokens and profile tokens in accordance with aspects of the present disclosure. The operations of the method 900 may be implemented by a client application or its components as described herein. For example, the operations of the method 900 may be performed by a client application as described with reference to FIGS. 1 through 8. In some examples, a client application may execute a set of instructions to control the functional elements of the client application to perform the described functions. Additionally, or alternatively, the client application may perform aspects of the described functions using special-purpose hardware.

At 905, the method may include displaying, at a user interface of a client application on a user device, information about one or more first tokens associated with a profile of a custodial token platform. The operations of 905 may be performed in accordance with examples as disclosed herein. In some examples, aspects of the operations of 905 may be performed by a profile token component 725 as described with reference to FIG. 7.

At 910, the method may include receiving, via the client application on the user device, a first input to connect a self-custody address to the profile of the custodial token platform. The operations of 910 may be performed in accordance with examples as disclosed herein. In some examples, aspects of the operations of 910 may be performed by a connection component 730 as described with reference to FIG. 7.

At 915, the method may include receiving, via the client application and after receiving the first input, a second input to authorize the custodial token platform to access information associated with the self-custody address and display information about one or more second tokens associated with the self-custody address at the client application. The operations of 915 may be performed in accordance with examples as disclosed herein. In some examples, aspects of the operations of 915 may be performed by an authorization component 735 as described with reference to FIG. 7.

At 920, the method may include obtaining an indication of the one or more second tokens associated with the self-custody address via one or more services associated with the custodial token platform, wherein at least one service of the one or more services stores an association between the profile of the custodial token platform and the self-custody address. The operations of 920 may be performed in accordance with examples as disclosed herein. In some examples, aspects of the operations of 920 may be performed by a self-custody address lookup component 740 as described with reference to FIG. 7.

At 925, the method may include updating the user interface of the client application, after obtaining the indication of the one or more second tokens, to include information about the one or more second tokens associated with the self-custody address concurrently with information about the one or more first tokens associated with the profile of the custodial token platform. The operations of 925 may be performed in accordance with examples as disclosed herein. In some examples, aspects of the operations of 925 may be performed by a self-custody address token component 745 as described with reference to FIG. 7.

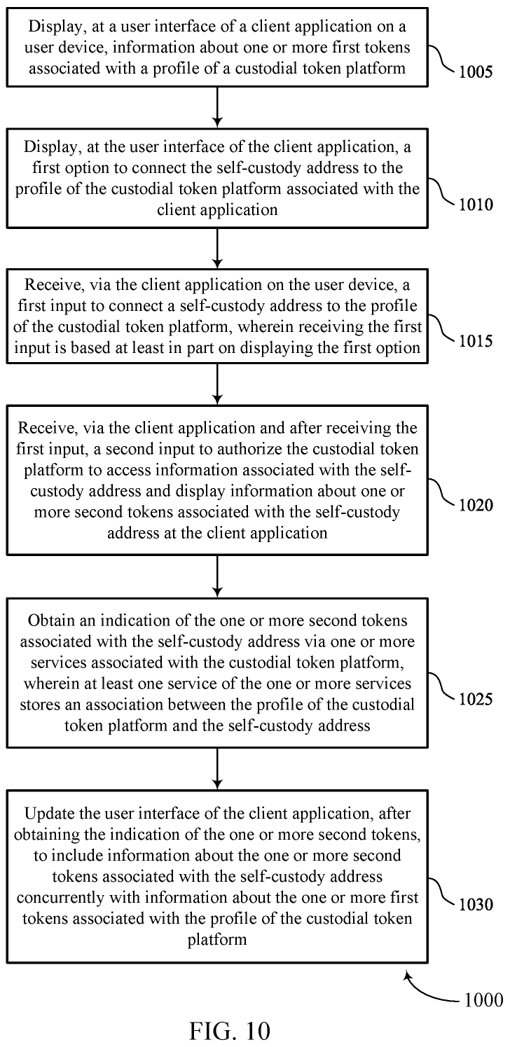

FIG. 10 shows a flowchart illustrating a method 1000 that supports synchronization and display of self-custody address tokens and profile tokens in accordance with aspects of the present disclosure. The operations of the method 1000 may be implemented by a client application or its components as described herein. For example, the operations of the method 1000 may be performed by a client application as described with reference to FIGS. 1 through 8. In some examples, a client application may execute a set of instructions to control the functional elements of the client application to perform the described functions. Additionally, or alternatively, the client application may perform aspects of the described functions using special-purpose hardware.

At 1005, the method may include displaying, at a user interface of a client application on a user device, information about one or more first tokens associated with a profile of a custodial token platform. The operations of 1005 may be performed in accordance with examples as disclosed herein. In some examples, aspects of the operations of 1005 may be performed by a profile token component 725 as described with reference to FIG. 7.

At 1010, the method may include displaying, at the user interface of the client application, a first option to connect the self-custody address to the profile of the custodial token platform associated with the client application. The operations of 1010 may be performed in accordance with examples as disclosed herein. In some examples, aspects of the operations of 1010 may be performed by a connection component 730 as described with reference to FIG. 7.

At 1015, the method may include receiving, via the client application on the user device, a first input to connect a self-custody address to the profile of the custodial token platform, wherein receiving the first input is based at least in part on displaying the first option. The operations of 1015 may be performed in accordance with examples as disclosed herein. In some examples, aspects of the operations of 1015 may be performed by a connection component 730 as described with reference to FIG. 7.

At 1020, the method may include receiving, via the client application and after receiving the first input, a second input to authorize the custodial token platform to access information associated with the self-custody address and display information about one or more second tokens associated with the self-custody address at the client application. The operations of 1020 may be performed in accordance with examples as disclosed herein. In some examples, aspects of the operations of 1020 may be performed by an authorization component 735 as described with reference to FIG. 7.

At 1025, the method may include obtaining an indication of the one or more second tokens associated with the self-custody address via one or more services associated with the custodial token platform, wherein at least one service of the one or more services stores an association between the profile of the custodial token platform and the self-custody address. The operations of 1025 may be performed in accordance with examples as disclosed herein. In some examples, aspects of the operations of 1025 may be performed by a self-custody address lookup component 740 as described with reference to FIG. 7.

At 1030, the method may include updating the user interface of the client application, after obtaining the indication of the one or more second tokens, to include information about the one or more second tokens associated with the self-custody address concurrently with information about the one or more first tokens associated with the profile of the custodial token platform. The operations of 1030 may be performed in accordance with examples as disclosed herein. In some examples, aspects of the operations of 1030 may be performed by a self-custody address token component 745 as described with reference to FIG. 7.

A method for data management by an apparatus is described. The method may include displaying, at a user interface of a client application on a user device, information about one or more first tokens associated with a profile of a custodial token platform, receiving, via the client application on the user device, a first input to connect a self-custody address to the profile of the custodial token platform, receiving, via the client application and after receiving the first input, a second input to authorize the custodial token platform to access information associated with the self-custody address and display information about one or more second tokens associated with the self-custody address at the client application, obtaining an indication of the one or more second tokens associated with the self-custody address via one or more services associated with the custodial token platform, wherein at least one service of the one or more services stores an association between the profile of the custodial token platform and the self-custody address, and updating the user interface of the client application, after obtaining the indication of the one or more second tokens, to include information about the one or more second tokens associated with the self-custody address concurrently with information about the one or more first tokens associated with the profile of the custodial token platform.

An apparatus for data management is described. The apparatus may include one or more memories storing processor executable code, and one or more processors coupled with the one or more memories. The one or more processors may individually or collectively be operable to execute the code to cause the apparatus to display, at a user interface of a client application on a user device, information about one or more first tokens associated with a profile of a custodial token platform, receive, via the client application on the user device, a first input to connect a self-custody address to the profile of the custodial token platform, receive, via the client application and after receiving the first input, a second input to authorize the custodial token platform to access information associated with the self-custody address and display information about one or more second tokens associated with the self-custody address at the client application, obtain an indication of the one or more second tokens associated with the self-custody address via one or more services associated with the custodial token platform, wherein at least one service of the one or more services stores an association between the profile of the custodial token platform and the self-custody address, and update the user interface of the client application, after obtaining the indication of the one or more second tokens, to include information about the one or more second tokens associated with the self-custody address concurrently with information about the one or more first tokens associated with the profile of the custodial token platform.

Another apparatus for data management is described. The apparatus may include means for displaying, at a user interface of a client application on a user device, information about one or more first tokens associated with a profile of a custodial token platform, means for receiving, via the client application on the user device, a first input to connect a self-custody address to the profile of the custodial token platform, means for receiving, via the client application and after receiving the first input, a second input to authorize the custodial token platform to access information associated with the self-custody address and display information about one or more second tokens associated with the self-custody address at the client application, means for obtaining an indication of the one or more second tokens associated with the self-custody address via one or more services associated with the custodial token platform, wherein at least one service of the one or more services stores an association between the profile of the custodial token platform and the self-custody address, and means for updating the user interface of the client application, after obtaining the indication of the one or more second tokens, to include information about the one or more second tokens associated with the self-custody address concurrently with information about the one or more first tokens associated with the profile of the custodial token platform.

A non-transitory computer-readable medium storing code for data management is described. The code may include instructions executable by one or more processors to display, at a user interface of a client application on a user device, information about one or more first tokens associated with a profile of a custodial token platform, receive, via the client application on the user device, a first input to connect a self-custody address to the profile of the custodial token platform, receive, via the client application and after receiving the first input, a second input to authorize the custodial token platform to access information associated with the self-custody address and display information about one or more second tokens associated with the self-custody address at the client application, obtain an indication of the one or more second tokens associated with the self-custody address via one or more services associated with the custodial token platform, wherein at least one service of the one or more services stores an association between the profile of the custodial token platform and the self-custody address, and update the user interface of the client application, after obtaining the indication of the one or more second tokens, to include information about the one or more second tokens associated with the self-custody address concurrently with information about the one or more first tokens associated with the profile of the custodial token platform.

Some examples of the method, apparatus, and non-transitory computer-readable medium described herein may further include operations, features, means, or instructions for displaying, at the user interface of the client application, a first option to connect the self-custody address to the profile of the custodial token platform associated with the client application, wherein receiving the first input may be based at least in part on displaying the first option.

Some examples of the method, apparatus, and non-transitory computer-readable medium described herein may further include operations, features, means, or instructions for displaying, at the user interface of the client application, a second option to download an application associated with the self-custody address and receiving, at the user device, a third input to download the application associated with the self-custody address, wherein displaying the first option to connect the self-custody address to the profile of the custodial token platform associated with the client application may be based at least in part on receiving the third input.

Some examples of the method, apparatus, and non-transitory computer-readable medium described herein may further include operations, features, means, or instructions for receiving, via the client application on the user device, a third input to connect a second self-custody address to the profile of the custodial token platform, obtaining, after receiving the third input, a second indication of one or more third tokens associated with the second self-custody address via the one or more services associated with the custodial token platform, and updating the user interface of the client application, after obtaining the second indication of the one or more third tokens, to include information about the one or more third tokens associated with the second self-custody address concurrently with information about the one or more first tokens associated with the profile of the custodial token platform and information about the one or more second tokens associated with the self-custody address.

Some examples of the method, apparatus, and non-transitory computer-readable medium described herein may further include operations, features, means, or instructions for obtaining a second indication of message activity associated with the self-custody address via one or more services associated with the custodial token platform and displaying, at the user interface of the client application and after obtaining the indication of the one or more second tokens, the second indication of the message activity associated with the self-custody address.

In some examples of the method, apparatus, and non-transitory computer-readable medium described herein, obtaining the indication may include operations, features, means, or instructions for obtaining an amount of tokens associated with the self-custody address, obtaining content of one or more NFTs associated with the self-custody address, or both.

In some examples of the method, apparatus, and non-transitory computer-readable medium described herein, receiving the second input to authorize the custodial token platform to access the information associated with the self-custody address and display the one or more second tokens associated with the self-custody address at the client application may include operations, features, means, or instructions for receiving the second input to authorize the custodial token platform to perform one or more activities via a blockchain network, the one or more activities comprising sending one or more third tokens from the profile to the self-custody address, sending the one or more third tokens from the self-custody address to the profile, purchasing the one or more third tokens via the custodial token platform, or any combination thereof.

In some examples of the method, apparatus, and non-transitory computer-readable medium described herein, the self-custody address may be associated with one or more keys, the one or more keys associated with a capability of the self-custody address to send, receive, store, or any combination thereof cryptographic tokens via a blockchain network.

In some examples of the method, apparatus, and non-transitory computer-readable medium described herein, the one or more first tokens associated with the profile of the custodial token platform may be stored by the custodial token platform on behalf of a user associated with the profile.

In some examples of the method, apparatus, and non-transitory computer-readable medium described herein, the one or more second tokens may be associated with the self-custody address according to one or more records on a blockchain data store associated with a blockchain network.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
displaying, at a user interface of a client application on a user device, information about one or more first tokens associated with a profile of a custodial token platform;
receiving, via the client application on the user device, a first input to connect a self-custody address to the profile of the custodial token platform;
receiving, via the client application and after receiving the first input, a second input to authorize the custodial token platform to access information associated with the self-custody address and display information about one or more second tokens associated with the self-custody address at the client application;
obtaining an indication of the one or more second tokens associated with the self-custody address via one or more services associated with the custodial token platform, wherein at least one service of the one or more services stores an association between the profile of the custodial token platform and the self-custody address; and
updating the user interface of the client application, after obtaining the indication of the one or more second tokens, to include information about the one or more second tokens associated with the self-custody address concurrently with information about the one or more first tokens associated with the profile of the custodial token platform.

2. The method of claim 1, further comprising:
displaying, at the user interface of the client application, a first option to connect the self-custody address to the profile of the custodial token platform associated with the client application, wherein receiving the first input is based at least in part on displaying the first option.

3. The method of claim 2, further comprising:
displaying, at the user interface of the client application, a second option to download an application associated with the self-custody address; and
receiving, at the user device, a third input to download the application associated with the self-custody address, wherein displaying the first option to connect the self-custody address to the profile of the custodial token platform associated with the client application is based at least in part on receiving the third input.

4. The method of claim 1, further comprising:
receiving, via the client application on the user device, a third input to connect a second self-custody address to the profile of the custodial token platform;
obtaining, after receiving the third input, a second indication of one or more third tokens associated with the second self-custody address via the one or more services associated with the custodial token platform; and
updating the user interface of the client application, after obtaining the second indication of the one or more third tokens, to include information about the one or more third tokens associated with the second self-custody address concurrently with information about the one or more first tokens associated with the profile of the custodial token platform and information about the one or more second tokens associated with the self-custody address.

5. The method of claim 1, further comprising:
obtaining a second indication of message activity associated with the self-custody address via one or more services associated with the custodial token platform; and
displaying, at the user interface of the client application and after obtaining the indication of the one or more second tokens, the second indication of the message activity associated with the self-custody address.

6. The method of claim 1, wherein obtaining the indication comprises:
obtaining an amount of tokens associated with the self-custody address, obtaining content of one or more non-fungible tokens (NFTs) associated with the self-custody address, or both.

7. The method of claim 1, wherein receiving the second input to authorize the custodial token platform to access the information associated with the self-custody address and display the one or more second tokens associated with the self-custody address at the client application further comprises:
receiving the second input to authorize the custodial token platform to perform one or more activities via a blockchain network, the one or more activities comprising sending one or more third tokens from the profile to the self-custody address, sending the one or more third tokens from the self-custody address to the profile, purchasing the one or more third tokens via the custodial token platform, or any combination thereof.

8. The method of claim 1, wherein the self-custody address is associated with one or more keys, the one or more keys associated with a capability of the self-custody address to send, receive, store, or any combination thereof cryptographic tokens via a blockchain network.

9. The method of claim 1, wherein the one or more first tokens associated with the profile of the custodial token platform are stored by the custodial token platform on behalf of a user associated with the profile.

10. The method of claim 1, wherein the one or more second tokens are associated with the self-custody address according to one or more records on a blockchain data store associated with a blockchain network.

11. An apparatus for data management, comprising:
one or more memories storing processor-executable code; and
one or more processors coupled with the one or more memories and individually or collectively operable to execute the code to cause the apparatus to:
display, at a user interface of a client application on a user device, information about one or more first tokens associated with a profile of a custodial token platform;
receive, via the client application on the user device, a first input to connect a self-custody address to the profile of the custodial token platform;
receive, via the client application and after receiving the first input, a second input to authorize the custodial token platform to access information associated with the self-custody address and display information about one or more second tokens associated with the self-custody address at the client application;
obtain an indication of the one or more second tokens associated with the self-custody address via one or more services associated with the custodial token platform, wherein at least one service of the one or more services stores an association between the profile of the custodial token platform and the self-custody address; and
update the user interface of the client application, after obtaining the indication of the one or more second tokens, to include information about the one or more second tokens associated with the self-custody address concurrently with information about the one or more first tokens associated with the profile of the custodial token platform.

12. The apparatus of claim 11, wherein the one or more processors are individually or collectively further operable to execute the code to cause the apparatus to:
display, at the user interface of the client application, a first option to connect the self-custody address to the profile of the custodial token platform associated with the client application, wherein receiving the first input is based at least in part on displaying the first option.

13. The apparatus of claim 12, wherein the one or more processors are individually or collectively further operable to execute the code to cause the apparatus to:
display, at the user interface of the client application, a second option to download an application associated with the self-custody address; and
receive, at the user device, a third input to download the application associated with the self-custody address, wherein displaying the first option to connect the self-custody address to the profile of the custodial token platform associated with the client application is based at least in part on receiving the third input.

14. The apparatus of claim 11, wherein the one or more processors are individually or collectively further operable to execute the code to cause the apparatus to:
receive, via the client application on the user device, a third input to connect a second self-custody address to the profile of the custodial token platform;
obtain, after receiving the third input, a second indication of one or more third tokens associated with the second self-custody address via the one or more services associated with the custodial token platform; and
update the user interface of the client application, after obtaining the second indication of the one or more third tokens, to include information about the one or more third tokens associated with the second self-custody address concurrently with information about the one or more first tokens associated with the profile of the custodial token platform and information about the one or more second tokens associated with the self-custody address.

15. The apparatus of claim 11, wherein the one or more processors are individually or collectively further operable to execute the code to cause the apparatus to:
obtain a second indication of message activity associated with the self-custody address via one or more services associated with the custodial token platform; and
display, at the user interface of the client application and after obtaining the indication of the one or more second tokens, the second indication of the message activity associated with the self-custody address.

16. A non-transitory computer-readable medium storing code for data management, the code comprising instructions executable by one or more processors to:
display, at a user interface of a client application on a user device, information about one or more first tokens associated with a profile of a custodial token platform;
receive, via the client application on the user device, a first input to connect a self-custody address to the profile of the custodial token platform;
receive, via the client application and after receiving the first input, a second input to authorize the custodial token platform to access information associated with the self-custody address and display information about one or more second tokens associated with the self-custody address at the client application;
obtain an indication of the one or more second tokens associated with the self-custody address via one or more services associated with the custodial token platform, wherein at least one service of the one or more services stores an association between the profile of the custodial token platform and the self-custody address; and
update the user interface of the client application, after obtaining the indication of the one or more second tokens, to include information about the one or more second tokens associated with the self-custody address concurrently with information about the one or more first tokens associated with the profile of the custodial token platform.

17. The non-transitory computer-readable medium of claim 16, wherein the instructions are further executable by the one or more processors to:
display, at the user interface of the client application, a first option to connect the self-custody address to the profile of the custodial token platform associated with the client application, wherein receiving the first input is based at least in part on displaying the first option.

18. The non-transitory computer-readable medium of claim 17, wherein the instructions are further executable by the one or more processors to:
display, at the user interface of the client application, a second option to download an application associated with the self-custody address; and
receive, at the user device, a third input to download the application associated with the self-custody address, wherein displaying the first option to connect the self-custody address to the profile of the custodial token platform associated with the client application is based at least in part on receiving the third input.

19. The non-transitory computer-readable medium of claim 16, wherein the instructions are further executable by the one or more processors to:
receive, via the client application on the user device, a third input to connect a second self-custody address to the profile of the custodial token platform;
obtain, after receiving the third input, a second indication of one or more third tokens associated with the second self-custody address via the one or more services associated with the custodial token platform; and
update the user interface of the client application, after obtaining the second indication of the one or more third tokens, to include information about the one or more third tokens associated with the second self-custody address concurrently with information about the one or more first tokens associated with the profile of the custodial token platform and information about the one or more second tokens associated with the self-custody address.

20. The non-transitory computer-readable medium of claim 16, wherein the instructions are further executable by the one or more processors to:
obtain a second indication of message activity associated with the self-custody address via one or more services associated with the custodial token platform; and
display, at the user interface of the client application and after obtaining the indication of the one or more second tokens, the second indication of the message activity associated with the self-custody address.
